(19) United States
(12) Patent Application Publication
(10) Pub. No.: US 2013/0012215 A1
(43) Pub. Date: Jan. 10, 2013

(54) SYSTEM AND METHOD FOR COMMUNICATION NETWORK SWITCHING

(75) Inventor: Jong-Won SEO, Gyeonggi-do (KR)

(73) Assignee: SAMSUNG ELECTRONICS CO., LTD., Gyeonggi-do (KR)

(21) Appl. No.: 13/529,119

(22) Filed: Jun. 21, 2012

(30) Foreign Application Priority Data
Jul. 4, 2011 (KR) 10-2011-0066007

(51) Int. Cl. H04W 8/00

(52) U.S. Cl. 455/450

(57) ABSTRACT

Disclosed are a system and a method for switching between communication networks, by which a portable terminal can switch from a currently connected communication network to a target communication network within reduced time and with only minimum information. The communication network switching system includes a first communication network configured to transmit only minimum information for call setup among available information of a second communication network to a portable terminal when there is a request for a service of the second communication network by the portable terminal connected to the first communication network. The portable terminal connects to the second communication network and performs the service of the second communication network by using only the minimum information for call setup, thereby reducing delay time for initiating the second service.

### CLAIM OF PRIORITY

This application claims priority under 35 U.S.C. §119(a) of an application entitled “System And Method For Communication Network Switching” filed in the Korean Intellectual Property Office on Jul. 4, 2011 and assigned Serial No. 10-2011-0066007, the contents of which are hereby incorporated by reference.

### BACKGROUND

1. Technical Field

This disclosure relates generally to wireless telecommunications and more particularly to a system and method for switching between wireless communication networks.

2. Description of the Related Art

A network conforming to the Long Term Evolution (LTE) Worldwide Interoperability for Microwave (WiMAX) protocols supports data communication with an all IP, packet switched platform. When a voice call service is requested from a portable terminal already connected to an LTE WiMAX network, a handover is typically made from the LTE or WiMAX network to a UMTS/GSM CDMA1x network to handle the voice call.

NAn operation of a portable terminal switching from a currently connected network for a data service to another (target) network for a voice call service will now be briefly described. For example, a voice call service may be requested from a portable terminal which has currently established a Radio Resource Control (RRC) connection with an LTE network. In this case, the LTE network transmits cell information (Cell Info), which contains information about a target UMTS/GSM network, together with an instruction to switch to that UMTS/GSM network, to the portable terminal and releases the RRC connection.

Thereafter, the portable terminal determines whether it can switch to the UMTS/GSM network, and performs a procedure known as “Camp on the target cell” in which the portable terminal decodes the cell information (including MIB, SIB1, SIB3, SIB5, SIB7, SIB11, etc.) received from the LTE network. The portable terminal sends a request for an RRC connection to the UMTS/GSM network through SIB5 and SIB7 for call setup among the information acquired through the “Camp on the target cell” procedure. Upon receiving an RRC connection establishment message from the UMTS/GSM network, the portable terminal establishes the RRC connection with the UMTS/GSM network and uses a voice call service.

However, the procedure as described above requires excessive Radio Access Technology (RAT) switching time required for switching from the currently connected communication network to the target network. The procedure further requires excessive time for acquisition of the target network for the voice call service. The net result is an undesirable delay in establishing actual voice communication over the target network.

### SUMMARY

Disclosed are a system and a method for switching between communication networks, by which a portable terminal can switch from a currently connected communication network to a target communication network within reduced time and with the use of only minimal or substantially minimal information.

In accordance with an aspect of the present invention, there is provided a communication network switching system and corresponding method including a first communication network configured to transmit only minimum information for call setup, among available information of a second communication network, to a portable terminal when the portable terminal requests, while connected to the first communication network, a type of service supported by the second communication network. The portable terminal connects to the second communication network and performs the service of the second communication network by using only the minimum information for call setup.

In accordance with another aspect of the present invention, there is provided a communication network switching method including: transmitting, by a first communication network, only minimum information for call setup among available information of a second communication network to a portable terminal when the terminal, while connected to the first communication network, requests a type of service supported by the second communication network; and connecting to the second communication network and performing the service of the second communication network by the portable terminal by using the minimum information for call setup received from the first communication network.

In accordance with another aspect of the present invention, there is provided a method implemented in a portable terminal which includes: connecting to a first communication network to perform a first type of service; when requesting a second type of service while connected to the first communication network, receiving only minimum information for call setup with a second communication network, among available information of the second communication network, the minimum information being transmitted by the first communication network; and connecting to the second communication network and performing the second type of service with the second communication network by using the minimum information for call setup.

### BRIEF DESCRIPTION OF THE DRAWINGS

The above and other aspects, features and advantages of the present invention will be more apparent from the following detailed description taken in conjunction with the accompanying drawing, in which:

FIG. 1 is a signal flow diagram illustrating a procedure of switching between communication networks according to an embodiment of the present invention.

### DETAILED DESCRIPTION

Hereinafter, exemplary embodiments of the present invention will be described with reference to the accompanying drawings.

The following description of exemplary embodiments of the present invention is based on, as an example, a communication network switching procedure for switching from a first communication network currently connected for a data service to a second communication capable of supporting a voice call service. However, in other implementations, the present invention can be applied to a network switching procedure for switching from a second communication network currently connected for a voice call service to a first communication network to support a data communication service.

Further, the following description of exemplary embodiments of the present invention is based on, as an example, an LTE network as the first communication network for a data communication service and a UMTS/GSM network as the second communication network for a voice call service. In other implementations, an LTE network can serve as the second communication network for the data communication service and the UMTS/GSM network can serve as the first network for the voice call service. Furthermore, it is contemplated that networks operating according to other data communication protocols such as a WiMax network may be substituted for the LTE network, and other types of networks can be substituted for the UMTS/GSM network without departing from the scope of the present invention.

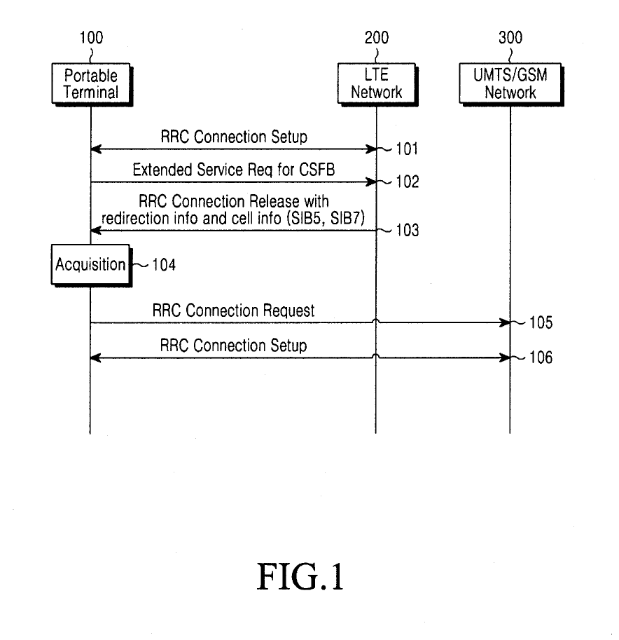

FIG. 1 is a signal flow diagram illustrating a procedure of switching to a communication network according to an embodiment of the present invention. In step 101, the portable terminal 100 establishes an RRC connection setup with an LTE network 200 and then performs a data communication service. LTE network 200 is, for example, a network complaint with 3GPP TS 36.331 version 10.0.0 Release 10. Some aspects of the LTE protocol pertinent to this disclosure are described in technical specification 3GPP TS 36.331 version 10.0.0 Release 10, by the ETSI 3rd generation partnership project, the contents of which are expressly incorporated herein by reference.

The portable terminal 100 having established the RRC connection with the LTE network 200 then requests a voice call service from the LTE network 200 (Extended Service Req for CSFB) in step 102.The LTE network 200 responds to this request in step 103 by transmitting minimum information for call setup with a target UMTS/GSM network 300, to the portable terminal 100. This minimum information for call setup is only a subset of available cell information (Cell info) containing information about the target UMTS/GSM network 300 that would conventionally be transmitted by the LTE network 200 in accordance with the LTE specification referenced hereinabove. (In the conventional case, other available information for the target network would include MIB, SIB1, SIB2, etc., of the “Camp on the target cell” procedure.) The minimum information for call setup includes a System Information Block 5 (SIB5) and a System Information Block 7 (SIB7).

Accompanying the transmission of the minimum information, in step 103 the LTE network transmits a “switch message”, i.e., a handover message, containing redirection information identifying UMTS/GSM network 300. Additionally, at this time, LTE network 200 releases the RRC connection with the portable terminal 100 (RRC Connection Release with redirection info and cell info).

A SIB5 (SystemInformationBlockType5) message contains information relevant only for inter-frequency cell re-selection, i.e., information about other E-UTRA frequencies and inter-frequency neighboring cells relevant for cell re-selection. The SIB5 includes cell re-selection parameters common for a frequency as well as cell specific re-selection parameters. Field descriptions of SIB5 can include: p-Max; threshX-High; threshX-low; t-ReselectionEUTRA; t-ReselectionEUTRA-SF; q-OffsetFreq; interFreqNeighCellList; q-OffsetCell; interFreqBlackCellList; q-QualMin; threshX-highQ; and threshX-LowQ, where the relevant parameters are specified in specification 3GPP TS 36.304, “Evolved Universal Terrestrial Radio Access (E-UTRA); UE Procedures in IdleMode”, which is incorporated herein by reference.

A SIB7 (SystemInformationBlockType7) message contains information relevant only for inter-RAT cell re-selection, i.e. information about GERAN frequencies relevant for cell re-selection. The SIB7 message includes cell re-selection parameters for each frequency. SIB7 field descriptions can include: carrierFreqsInfoList; carrierFreqs; commonInfo; t-ReselectionGERAN; t-ReselectionGERAN-SF; ncc-Permitted; q-RxLevMin; p-MaxGERAN; threshX-High; and threshX-Low, as specified in TS 36.304.

At step 104 (Acquisition), when the portable terminal 100 has received the minimum information (SIB5, SIB7) for call setup among the cell information (Cell info) containing information about the target UMTS/GSM network 300 together with a handover message to the UMTS/GSM network 300 from the LTE network 200, the portable terminal 100 determines whether it is currently possible to connect to the UMTS/GSM network 300.

After confirming that it is currently possible to connect to the UMTS/GSM network 300, the portable terminal 100 sends a request (RRC Connection Request) for an RRC connection, in step 105, through a random access channel (RACH) to the UMTS/GSM network 300. This is done by using only the minimum information (SIB5 and SIB7) for call setup received from the LTE network 300, i.e., without the need for a “Camp on the target cell” procedure that decodes all information (MIB, SIB1, SIB3, SIB5, SIB7, SIB11, etc.) about the UMTS/GSM network 300.

Thereafter, when the portable terminal 100 has received an RRC connection setup message through a forward access channel (FACH) from the UMTS/GSM network 300, the portable terminal 100 and the UMTS/GSM network 300 perform step 106 for establishing of the RRC connection.

In step 106, the portable terminal 100, which has established the RRC connection with the UMTS/GSM network 300, performs the voice call service through the UMTS/GSM network 300.

As described above, by performing a communication network switching by using minimal, or substantially minimal information for call setup, a “Camp on the target cell” procedure that is conventionally performed as part of the handover operation can be skipped and the procedure of RRC Connection Request can be immediately performed, so as to reduce the time for the call setup.

Accordingly, embodiments of the present invention provide a system and a method for switching between communication networks, by which a portable terminal can switch from a currently connected communication network to a target communication network within reduced time and with only minimum information without performing additional conventional procedures.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A communication network switching system comprising:
a first communication network configured to transmit only minimum information for call setup among available information of a second communication network, to a portable terminal when there is a request for a type of service supported by the second communication network by the portable terminal connected to the first communication network; and
the portable terminal configured to connect to the second communication network and perform the service of the second communication network by using the minimum information for call setup received from the first communication network.

2. The communication network switching system of claim 1, wherein the portable terminal connection to the first communication network is a Radio Resource Control (RRC) connection, and
the first communication network transmits information for switching to the second communication network, together with the minimum information for call setup among the information on the second communication network, to the portable terminal and releases the RRC connection with the portable terminal.

3. The communication network switching system of claim 1, wherein the minimum information for call setup among the information on the second communication network comprises a System Information Block 5 (SIB5) and a System Information Block 7 (SIB7).

4. The communication network switching system of claim 1, wherein the portable terminal determines whether it is possible to connect to the second communication network when receiving the minimum information for call setup among the available information of the second communication network from the first communication network, sends a request for an RRC connection to the second communication network by using the minimum information for call setup, and establishes the RRC connection with the second communication to perform the service when receiving an RRC connection establishment message from the second communication network.

5. The communication network switching system of claim 4, wherein, after confirming that the portable terminal can connect to the second communication network, the portable terminal sends a request for the RRC connection to the second communication network by using the minimum information for call setup without a “Camp on the target cell” procedure in which all the available information about the second communication network is decoded.

6. The communication network switching system of, wherein the first communication network supports a data service and the second communication network supports a voice call service.

7. The communication network switching system as claimed in claim 1, wherein the first communication network supports a voice call service and the second communication network supports a data service.

8. A communication network switching method comprising:
transmitting, by a first communication network, only minimum information for call setup among available information of a second communication network to a portable terminal, when the portable terminal, while connected to the first communication network, requests a type of service supported by the second communication network; and
connecting to the second communication network and performing the service of the second communication network by the portable terminal by using the minimum information for call setup received from the first communication network.

9. The communication network switching method of claim 8, wherein transmitting of the minimum information for call setup comprises:
when there is a request for the service of the second communication network from the portable terminal having established a Radio Resource Control (RRC) connection, transmitting information for switching to the second communication network, together with the minimum information for call setup among the information on the second communication network, to the portable terminal and releasing the RRC connection with the portable terminal by the first communication network.

10. The communication network switching method of claim 8, wherein the minimum information for call setup among the information on the second communication network comprises a System Information Block 5 (SIB5) and a System Information Block 7 (SIB7).

11. The communication network switching method of claim 8, wherein connecting of the portable terminal to the second communication network to perform the service comprises:
determining, by the portable terminal, whether it is possible to connect to the second communication network, when receiving the minimum information for call setup among the information on the second communication network from the first communication network;
sending a request for a Radio Resource Control (RRC) connection to the second communication network by using the minimum information for call setup when it is possible to connect to the second communication; and
establishing the RRC connection with the second communication network to perform the service when an RRC connection establishment message is received from the second communication network.

12. The communication network switching method of claim 11, wherein, when it is possible to connect to the second communication network, the portable terminal sends a request for the RRC connection to the second communication network by using the minimum information for call setup without a “Camp on the target cell” procedure in which all information about the second communication network is decoded.

13. The communication network switching method of claim 8, wherein the first communication network supports a data service and the second communication network supports a voice call service.

14. The communication network switching method of claim 8, wherein the first communication network supports a voice call service and the second communication network supports a data service.

15. A method implemented in a portable terminal, comprising:
connecting to a first communication network to perform a first type of service;
when requesting a second type of service while connected to the first communication network, receiving only minimum information for call setup with a second communication network, among available information of the second communication network, the minimum information being transmitted by the first communication network; and
connecting to the second communication network and performing the second type of service with the second communication network by using the minimum information for call setup.

16. The method of claim 15, wherein the minimum information comprises SIB5 and SIB7 messages.

17. The method of claim 16, wherein the first communication network is an LTE network compliant with 3GPP TS 36.331 version 10.0.0 Release 10, and the second communication network is a UMTS/GSM network.

18. The method of claim 15 wherein the first type of service is a data service and the second type of service is a voice service.
